(19) United States
(12) Patent Application Publication
(10) Pub. No.: US 2014/0049215 A1
(43) Pub. Date: Feb. 20, 2014

(54) METHOD FOR MONITORING THE CHARGING MODE OF AN ENERGY STORE IN A VECHILE AND CHARGING SYSTEM FOR CHARGING AN ENERGY STORE IN A VECHILE

(71) Applicant: Jochen Fassnacht, Calw (DE)

(72) Inventor: Jochen Fassnacht, Calw (DE)

(21) Appl. No.: 13/879,091

(22) PCT Filed: Aug. 30, 2011
(86) PCT No.: PCT/EP2011/064867

§ 371 Date: Oct. 24, 2013

(30) Foreign Application Priority Data
Oct. 12, 2010 (DE) 10 2010 042 328.9

(51) Int. Cl. H02J 7/00

(52) U.S. Cl. CPC H02J 7/0052
USPC 320/109; 320/162

(57) ABSTRACT

In a method for monitoring the charging mode of an energy store in a vehicle which is drivable via an electric machine, the energy store is connected in the charging mode to an external energy supply system via a charging circuit which includes a unit operated as the boost converter, a controllable rectifier having upstream filter capacitors, and a system filter. A DC link capacitor is switched in parallel to the energy store. During the charging mode, at least one current and/or one voltage is monitored at the input, at the output, and/or within the charging circuit, and/or a function of a control unit of the rectifier and/or of the unit operated as the boost converter is monitored. If malfunction is detected, the charging circuit is switched into a free-running mode.

### BACKGROUND OF THE INVENTION

1. Field of the Invention

The present invention relates to a method for monitoring the charging mode of an energy store in a vehicle and to a charging system for charging an energy store in a vehicle.

2. Description of the Related Art

Vehicles (electric vehicles, plug-in hybrid vehicles) have been known for a long time which are electrically driven at least partially and have energy stores in the form of traction batteries which are chargeable via a vehicle-external power supply system, in particular the public power grid. For this purpose, the electrical system of the vehicle is connected via a recharger cable to a one-phase or three-phase plug of the public power grid, depending on the design of the electric main engine. To enable charging at every suitable plug of the public power grid, chargers, so-called on board chargers, are to be provided in the vehicles. The chargers are in this case generally designed as separate components. To build electric vehicles or plug-in hybrid vehicles in a simpler and more cost-effective way in the future, the use of already present components for multiple purposes suggests itself.

A device is known from published European patent application document EP 0 834 977 A2 for charging at least one accumulator, in particular an accumulator for an electrically driven vehicle, having a three-phase motor and a pulse-controlled inverter, controllable by a control unit, which is switched between the accumulator and the three-phase motor in which parts of this device, which are used for operating the vehicle, are usable during the charging process. Here, the pulse-controlled inverter is, in particular, operated together with the three-phase motor as the boost converter which is necessary to raise the voltage level of the power network to the voltage level of the high-voltage electrical system of the vehicle.

It must be considered that the coil or choke currents of the boost converter cannot abruptly stop flowing regardless of its implementation as a separate circuit unit by appropriately operating an inverter together with a three-phase motor, so that over-currents and overvoltages may occur in the charging circuit or in the adjoining circuits or components in the case of error.

### BRIEF SUMMARY OF THE INVENTION

The present invention provides a method for monitoring the charging mode of an energy store, in particular of a traction battery, in Is a vehicle which is drivable via an electric machine, in particular a three-phase machine. Here, the electric machine is connected to the energy store via a vehicle electrical system and may be supplied with electrical power from the energy store. During the charging mode, the energy store is connected to an external power supply system, in particular a public power grid, via a charging circuit which includes a unit operated as the boost converter, a controllable rectifier, in particular a pulsed rectifier, having upstream filter capacitors and a system filter. ADC link capacitor is switched in parallel to the energy store. According to the present invention, during the charging mode, at least one current and/or one voltage is/are monitored at the input, at the output, and/or within the charging circuit, and/or a function of a control unit of the rectifier and/or of the unit operated as the boost converter, and the charging circuit is switched into a free-running mode, if the at least one current exceeds a predefinable current threshold value or the at least one voltage exceeds a predefinable voltage threshold value, or a malfunction of the control unit of the rectifier and/or of the unit operated as the boost converter is detected. The free-running mode of the charging circuit is in this case implemented by a branch of the controllable rectifier and all circuit elements, which are controllable in the boost converter mode of the unit operated as the boost converter, are connected through.

Furthermore, the present invention provides a charging system for charging an energy store, in particular a traction battery, in a vehicle including:
an electric machine, in particular a three-phase machine, for driving the vehicle,
the energy store for supplying the electric machine with energy during the driving mode,
a vehicle electrical system via which the electric machine and the energy store are electrically connected,
a DC link capacitor which is switched in parallel to the energy store,
a charging circuit which includes a unit operated as the boost converter, a controllable rectifier, in particular a pulsed rectifier, having upstream filter capacitors and a system filter via which the energy store is connectable to an external power supply system, in particular a public power grid, during a charging mode,
at least one monitoring unit which monitors at least one current and/or one voltage at the input, at the output, and/or within the charging circuit, and/or a function of a control unit of the rectifier and/or of the unit operated as the boost converter is monitored, and
an evaluation unit which switches the charging circuit into a free-running mode in which one branch of the controllable rectifier and all circuit elements controllable in the boost converter mode of the unit operated as the boost converter, i.e., those which are connected to a negative DC link bus, are connected through for the case that the at least one current exceeds a predefinable current threshold value or the at least one voltage exceeds a predefinable voltage threshold value, or a malfunction of the control unit of the rectifier and/or of the unit operated as the boost converter is detected.

If an error occurs in the area of the power supply system or of the charging circuit, or of the control units assigned to the individual components of the charging circuit, the coil or choke currents of the boost converter do not stop flowing abruptly. Consequently, over-currents and/or overvoltages, which may result in permanent damage to circuit components, may occur in the charging circuit or in the adjoining circuits or components in the case of error. Such damage must, however, be prevented under any circumstances. The switch-off concept according to the present invention accomplishes this with the aid of very simple circuitry-related means. By simply connecting through a branch of the controllable rectifier and all circuit elements controllable in the boost converter mode of the unit operated as the boost converter, a free-running mode of the charging circuit is implemented in which the coil currents may continue to flow and the coil energy may be slowly reduced or “burned” in the coil resistors as well as in the power semiconductors present in the charging circuit. The free-running mode thus represents a type of a secure state for the charging circuit. The switchover into the free-running mode may take place very rapidly, so that damage to circuit components may be reliably prevented.

The unit operated as the boost converter may naturally be a “classic” boost converter. If the electric machine is in the driving mode but is controlled via an inverter, in particular a pulse-controlled inverter, operating the inverter in the charging mode as the boost converter, however, suggests itself in order to save additional costs and installation space. The coils or chokes necessary for the function of a boost converter may advantageously be formed by the stator windings of the electric machine. If these windings are not sufficient, additional coils or chokes may be provided. In the free-running mode of the charging circuit, only those circuit elements of the inverter must be connected through in this case which are activated in the boost converter mode of the inverter, i.e., only the low-side switches.

According to one specific embodiment of the present invention, the rectifier includes a freewheeling diode which is switched in parallel to the rectifier branches. In this way, one branch of the rectifier is always connected, so to speak, so that another is rectifier branch does not have to be connected through for the free-running mode.

Various errors may occur in the charging mode of the energy store. For example, a battery contactor may abruptly open or the connection to the high-voltage vehicle electrical system may be interrupted abruptly. In this case, the DC link capacitor continues to be charged by the coil currents, and the voltage in the DC link may reach inadmissibly high values. Therefore, it is provided according to one specific embodiment of the present invention to monitor a voltage at the DC link capacitor with the aid of a first monitoring unit and to switch the charging circuit by an evaluation circuit into the free-running mode, if the voltage at the DC link capacitor exceeds a predefinable DC link voltage threshold value.

In the case of a short circuit in the vehicle electrical system, the coil current would continue to flow through the short-circuited location and heat it additionally. To prevent this from happening, the charging current of the energy store may be monitored with the aid of a second monitoring unit and switched into the free-running mode, as soon as the charging current exceeds a predefinable charging current threshold value.

Even in the case of an abrupt failure of a system phase, the coil current would continue to flow and would then charge the filter capacitors which are upstream from the rectifier. Due to this undesirable charging, overvoltages may occur at the filter capacitors. To prevent this from happening, it is provided according to another specific embodiment of the present invention to monitor the voltages at the filter capacitors with the aid of a third monitoring unit and to switch into the free-running mode as soon as at least one of these voltages is above a predefinable filter voltage threshold value.

In the event of a crash of a control unit of the rectifier or of the inverter, either a new pulse pattern would no longer be set or the active voltage vector would no longer be left. However, this too could result in inadmissible currents. For this reason, the function of these control units may also be monitored with the aid of a fourth monitoring unit, e.g., in the form of a watchdog component, and switched immediately into the free-running mode as soon as the watchdog has responded, i.e., as soon as a malfunction is detected.

Even in the event of over-currents at the coils, in the power supply system, or in the system filter, as well as in the event of other measured values lacking plausibility or errors in the system, it is advantageous to switch the charging circuit into the free-running mode. Therefore, a fifth monitoring unit may be provided which monitors a current at the input of and/or within the charging circuit.

Further features and advantages of specific embodiments of the m present invention result from the following description with reference to the appended drawings.

### BRIEF DESCRIPTION OF THE DRAWINGS

FIG. 1 shows a schematic representation of a charging system according to the present invention.

FIG. 2 shows the charging system from FIG. 1 having a charging circuit in the free-running mode.

### DETAILED DESCRIPTION OF THE INVENTION

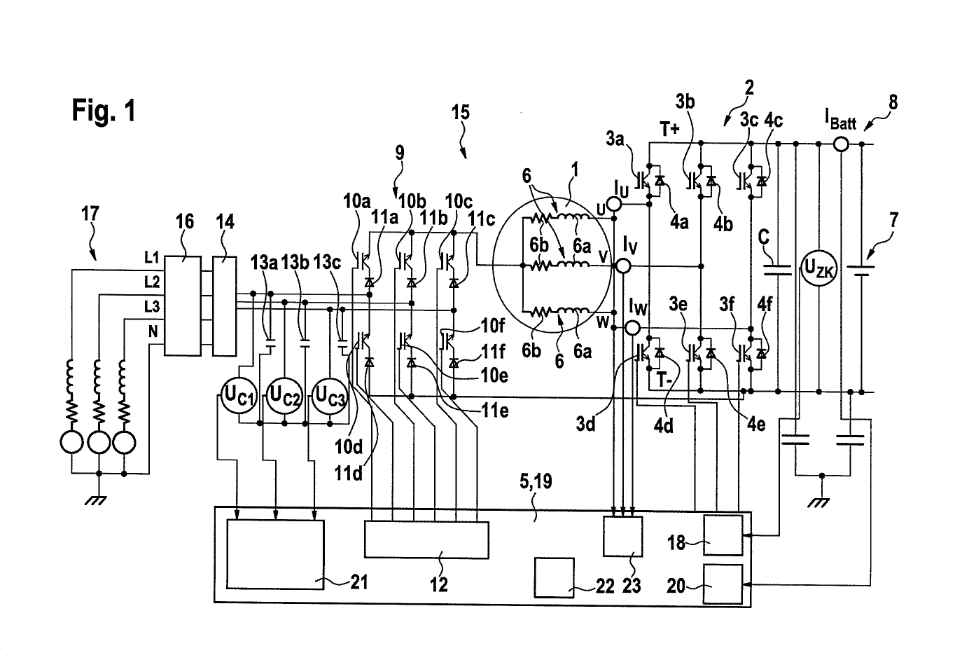

FIG. 1 shows a schematic representation of a charging system according to the present invention. An inverter in the form of a pulse-controlled inverter 2 is connected to a three-phase electric machine 1. Pulse-controlled inverter 2 includes multiple power components—often also referred to as power semiconductors—in the form of controllable circuit elements 3a through 3f which are connected to individual phases U, V, W of electric machine 1, and phases U, V, W switch either against a high reference potential T+ or a low reference potential T−. Circuit elements 3a through 3c which are connected to high reference potential T+ are also referred to here as high-side switches, and circuit elements 3d through 3f which are connected to low reference potential T− are referred to as low-side switches. Pulse-controlled inverter 2 also includes other power components in the form of freewheeling diodes 4a through 4f which are situated in the illustrated exemplary embodiment in the form of a six-pulse-controlled inverter bridge circuit. Here, a diode 4a through 4f is in each case situated in parallel to one of power circuit elements 3a through 3f. The power circuit elements may, for example, be designed as IGBTs (Insulated Gate Bipolar Transistors) or as MOSFETs (Metal Oxide Semiconductor Field-Effect Transistors). Pulse-controlled inverter 2 determines the power and operating mode of electric machine 1 in the driving mode and is accordingly activated by a control unit 5.

Electric machine 1 is used as a power plant of the vehicle and is designed in the illustrated exemplary embodiment as a three-phase machine, but it may also have fewer or more than three phases. Electric machine 1 has stator windings 6 which are illustrated in the form of an equivalent circuit diagram by an inductance 6a and an ohmic resistor (coil resistor) 6b and are interconnected in a manner known per se by way of a star connection.

To supply electric machine 1 with energy, an energy store 7 is provided here in the form of a battery. Energy store 7 is connected via an on board vehicle electrical system 8 to electric machine 1 and other not illustrated vehicle components. Energy store 7 may in this case be implemented as a high-voltage battery, and the vehicle electrical system may, for example, be implemented as a high-voltage traction system in a hybrid vehicle. If the vehicle is designed as a hybrid vehicle, electric machine 1 may optionally also be operated in generator mode, mechanical energy being is converted into electrical power and stored in energy store 7.

A so-called DC link capacitor C, which is essentially used for stabilizing the battery voltage, is situated in parallel to pulse-controlled inverter 2 and energy store 7.

A controllable rectifier in the form of a pulsed rectifier 9 is connected upstream from electric machine 1. Pulsed rectifier 9 is a pulsed bridge rectifier known per se having multiple power components—often also referred to as power semiconductors—in the form of controllable circuit elements 10a through 10f. Rectifier 9 also includes other power components in the form of freewheeling diodes 11a through 11f. Here, a diode 11a through 11f is in each case situated in series to one of power circuit elements 10a through 10f. Circuit elements 10a through 10f of rectifier 9 are activated by a control unit 12. Control unit 12 is illustrated here as an integral part of control unit 5 of pulse-controlled inverter 3, but it may also be implemented as a separate control unit.

Together with filter capacitors 13a through 13c and a system filter 14, which are upstream from rectifier 9, rectifier 9, electric machine 1, and pulse-controlled inverter 2 together forma charging circuit 15 which, for charging purposes, connects energy store 7 to a vehicle-external power supply system 17, e.g., the public power grid, via an on board connecting element 16, e.g., in the form of a vehicle-side plug, e.g., via a recharger cable. On board power supply system 17 is illustrated as a three-phase electrical system, but it may also be designed as a one-phase electrical system. Alternatively to the illustrated specific embodiment, filter capacitors 13a through 13c may also be integrated into system filter 14 which is used for EMC interference suppression (EMC=electromagnetic compatibility).

In the charging mode, pulse-controlled inverter 2 is operated as the boost converter, only low-side switches 3d through 3f being activated. Stator windings 6 are used in this case as chokes of the boost converter. If inductances 6a of stator windings 6 are not sufficient, additional charging chokes (not illustrated) may be provided. It is advantageous during the charging mode to block the rotor of electric machine 1 in order to reliably prevent the vehicle from starting.

Naturally, the function of the boost converter necessary for charging energy store 7 may also be implemented by a separate boost converter.

If an error occurs during the charging mode in the area of the power supply system or of the charging circuit, or of the individual components of the control units assigned to the charging circuit, the coil or choke currents of the boost converter do not stop flowing abruptly. Consequently, over-currents and/or overvoltages, which may result in permanent damage to circuit components, may occur in the charging circuit or in the adjoining circuits or components in the case of error.

To prevent this from happening, a first monitoring unit 18 is provided to monitor a voltage U_{ZK} at DC link capacitor C. If voltage U_{ZK} at DC link capacitor C exceeds a predefinable DC link voltage threshold value, which may, for example, result from an abrupt opening of a battery contactor or from an abrupt interruption of the connection to the high-voltage vehicle electrical system, charging circuit 15 is switched into a free-running mode by an evaluation circuit 19 which is identical to control unit 5 of pulse-controlled inverter 2 in the illustrated specific embodiment. For this purpose, a branch of controllable rectifier 9 and all circuit elements controllable in the boost converter mode of the unit operated as the boost converter are connected through by the output of corresponding control signals. If pulse-controlled inverter 2 is used together with the electric machine and/or, if necessary, with other charging chokes as the boost converters, only is low-side switches 3d through 3f are connected through, since only they are controllable in the boost converter mode of pulse-controlled inverter 2.

Actively connecting through a branch of rectifier 9 maybe dispensed with when rectifier 9 includes a freewheeling diode (not illustrated) which is switched in parallel to the rectifier branches. In this case, one branch of rectifier 9 is always connected through, so to speak.

If the branch of rectifier 9, which is to be connected through, fails for whatever reason, an adjacent branch may also be used. Here, the type of failure should be considered. If a circuit element erroneously always conducts, this branch should also be connected through in the free-running mode. If a circuit element cannot be connected through in the desired free-running branch, an adjacent branch should be used. An erroneous failure to connect through may, for example, be ascertained by a continuous increase of the voltage at the choke, although this voltage should in fact already be dropping due to the through connection of a branch and the free-running mode resulting therefrom.

Alternatively to the illustrated specific embodiment, evaluation circuit 19 may also naturally be implemented as a separate unit.

A second monitoring unit 20 monitors a charging current I_{Batt} of energy store 7. If this charging current exceeds a predefinable charging current threshold value, charging circuit 15 is also switched into the free-running mode by evaluation circuit 19. In this way, damage to circuit components may be reliably prevented even in the case of a short-circuit in the vehicle electrical system.

Even in the case of an abrupt failure of a system phase, the coil current would continue to flow and would charge filter capacitors 13a through 13c. Due to this undesirable charging, overvoltages could occur at filter capacitors 13a through 13c. To prevent this from happening, a third monitoring unit 21 is provided which monitors voltages U_{C1}, U_{C2}, and U_{C3} at filter capacitors 13a through 13c. If at least one of these voltages U_{C1}, U_{C2}, or U_{C3} is above a predefinable filter voltage threshold value, evaluation circuit 19 switches charging circuit 15 into the free-running mode.

A fourth monitoring unit 22, which may be designed as a watchdog, for example, monitors the function of control unit 5 of the pulse-controlled inverter and control unit 12 of rectifier 9.

Alternatively to the illustrated specific embodiment, separate monitoring units could also be provided for this purpose. If a malfunction is detected, charging circuit 15 is switched into the free-running mode by evaluation circuit 19. In this way, over-currents may also be reliably prevented which may occur since, due to a crash of a control unit, a new pulse pattern may no longer be set or the active voltage vector may no longer be left.

Even in the event of over-currents at the coils, in the power supply system, or in the system filter, as well as in the event of other measured values lacking plausibility or errors in the system, it is advantageous to switch the charging circuit into the free-running mode. For this reason, a fifth monitoring unit 23 is provided which monitors phase currents Iᵤ, Iᵥ, and I_{w} of electric machine 1. If the sum of these phase currents Iᵤ, Iᵥ, and I_{w} exceeds a predefinable phase current threshold value, evaluation circuit 19 immediately switches charging circuit 15 into the free-running mode.

Monitoring units 18, 20, 21, 22, and 23 are illustrated in the illustrated exemplary embodiment as integral components of control unit 5 of pulse-controlled inverter 2 or of evaluation circuit 19. The monitoring units may, however, also be implemented as separate units.

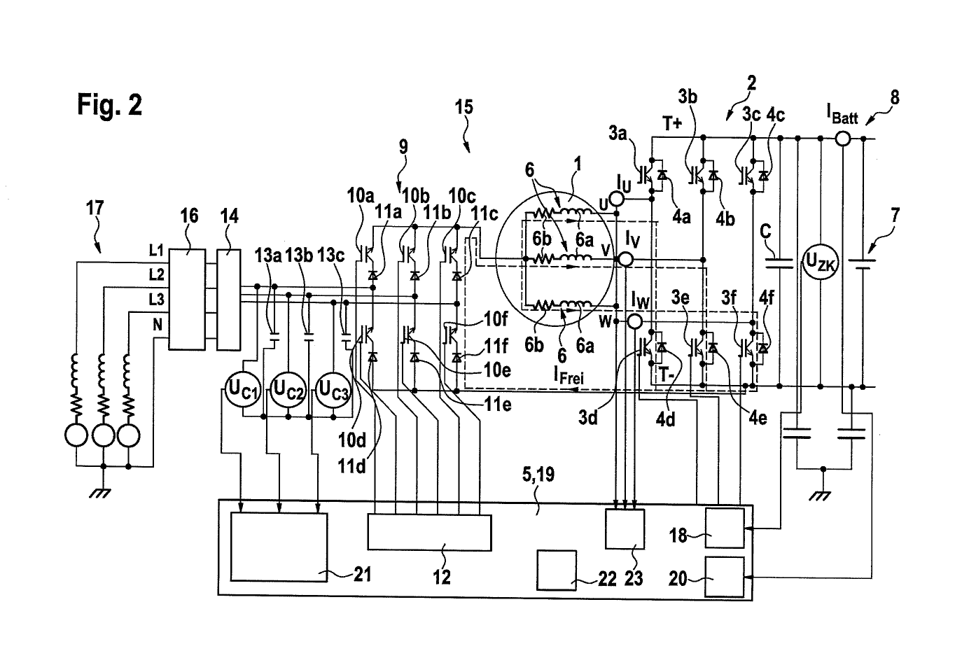

FIG. 2 schematically shows, characterized by a dashed line, a current flow I_{Free} in the free-running mode of charging circuit 15. Here, it is assumed, as an example, that the third rectifier branch of rectifier 9 (the right-hand branch of rectifier 9 in the figure) is connected through. Likewise, low-side switches 3d through 3f of pulse-controlled inverter 2 are connected through.

1-11. (canceled)

12. A method for monitoring a charging mode operation of an energy store in a vehicle which is drivable via a three-phase electric machine, wherein the electric machine is connected to the energy store via a vehicle electrical system and is supplied with electrical power from the energy store during a driving mode, and wherein during the charging mode the energy store is connected to an external public power grid, via a charging circuit which includes a unit operated as a boost converter, and a controllable rectifier having upstream filter capacitors and a system filter, and wherein a DC link capacitor is switched in parallel to the energy store, the method comprising:
monitoring, during the charging mode, at least one of (i) a current at least one of at an input, at an output, and within the charging circuit, (ii) a voltage at least one of at the input, at the output, and within the charging circuit, (iii) a function of a control unit of the rectifier, and (iv) a function of a control unit of the unit operated as the boost converter; and
switching the charging circuit into a free-running mode, wherein in the free-running mode one branch of the controllable rectifier and all circuit elements controllable in a boost converter mode of the unit operated as the boost converter are connected through, and wherein the switching into the free-running mode occurs if at least one of the following conditions is satisfied: the monitored current exceeds a predefined current threshold value;
the monitored voltage exceeds a predefined voltage threshold value; a malfunction of the control unit of the rectifier is detected; and a malfunction of the control unit of the unit operated as the boost converter is detected.

13. The method as recited in claim 12, wherein during the charging mode:
at least one of the following quantities is monitored: a voltage at the DC link capacitor, a charging current of the energy store, and voltages at the filter capacitors; and
the charging circuit is switched into the free-running mode if one of the following conditions is satisfied: the voltage at the DC link capacitor exceeds a predefined DC link capacitor voltage threshold value, the charging current of the energy store exceeds a predefined charging current threshold value, or at least one of the voltages at the filter capacitors exceeds a predefined filter voltage threshold value.

14. The method as recited in claim 13, wherein the electric machine is controlled via a pulse-controlled inverter in the driving mode, and wherein the inverter is operated as the boost converter in the charging mode.

15. The method as recited in claim 14, wherein inductances of the boost converter are formed at least partially by stator windings of the electric machine.

16. The method as recited in claim 14, wherein in the free-running mode of the charging circuit, all low-side switches of the inverter are connected through.

17. A charging system for charging an energy store in a vehicle, comprising:
a three-phase electric machine for driving the vehicle, wherein the energy store supplies the electric machine with energy during a driving mode;
a vehicle electrical system via which the electric machine and the energy store are electrically connected;
a DC link capacitor which is switched in parallel to the energy store;
a charging circuit which includes a unit operated as a boost converter, and a controllable rectifier having upstream filter capacitors and a system filter, wherein during a charging mode, the energy store is connected to an external public power grid via the charging circuit;
at least one monitoring unit which monitors at least one of (i) a current at least one of at an input, at an output, and within the charging circuit, (ii) a voltage at least one of at the input, at the output, and within the charging circuit, (iii) a function of a control unit of the rectifier, and (iv) a function of a control unit of the unit operated as the boost converter; and an evaluation unit which selectively switches the charging circuit into a free-running mode, wherein in the free-running mode one branch of the controllable rectifier and all circuit elements controllable in a boost converter mode of the unit operated as the boost converter are connected through, and wherein the switching into the free-running mode occurs if at least one of the following conditions is satisfied: the monitored current exceeds a predefined current threshold value; the monitored voltage exceeds a predefined voltage threshold value; a malfunction of the control unit of the rectifier is detected; and a malfunction of the control unit of the unit operated as the boost converter is detected.

18. The charging system as recited in claim 17, wherein:
a first monitoring unit monitors a voltage at the DC link capacitor;
a second monitoring unit monitors a charging current of the energy store;
a third monitoring unit monitors voltages at the filter capacitors;
a fourth monitoring unit monitors at least one of the function of the control unit of the rectifier and the function of the unit operated as the boost converter;
a fifth monitoring unit monitors at least one of the current at the input and the current within the charging circuit; and
the evaluation unit switches the charging circuit into the free-running mode if one of the following conditions is satisfied: the voltage at the DC link capacitor exceeds a predefined DC link capacitor voltage threshold value, the charging current of the energy store exceeds a predefined charging current threshold value, at least one of the voltages at the filter capacitors exceeds a predefined filter voltage threshold value, a malfunction of the control unit of the rectifier is detected, a malfunction of the control unit of the unit operated as the boost converter is detected, a current at the input exceeds a predefined input current threshold value, or a current within the charging circuit exceeds a predefined charging circuit current threshold value.

19. The charging system as recited in claim 17, wherein the electric machine is controlled via a pulse-controlled inverter in the driving mode, and wherein the inverter is operated as the boost converter in the charging mode.

20. The charging system as recited in claim 19, wherein inductances of the boost converter are formed at least partially by stator windings of the electric machine.

21. The charging system as recited in claim 18, wherein the fourth monitoring unit is implemented with the aid of a watchdog component.

22. The charging system as recited in claim 19, wherein the rectifier includes a freewheeling diode which is switched in parallel to the rectifier branches.
